(19) United States
(12) Patent Application Publication
(10) Pub. No.: US 2009/0150794 A1
(43) Pub. Date: Jun. 11, 2009

(54) REMOTE CONTROL SYSTEM AND METHOD OF CONTROLLING THE SAME

(75) Inventor: Akira Sano, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/328,502

(22) Filed: Dec. 4, 2008

(30) Foreign Application Priority Data
Dec. 6, 2007 (JP) 2007-316359

(51) Int. Cl. G06F 3/048

(52) U.S. Cl. 715/740

(57) ABSTRACT

A remote control system capable of changing the control window layout in accordance with a process where a controlled apparatus is used is provided. The controlled apparatus includes a management unit which manages the apparatus status of the controlled apparatus, and a generation unit which generates UI window candidate information. A remote control terminal acquires display priority information of each apparatus status, and displayable area information of the remote control window. The remote control terminal receives the UI window candidate information and determines, based on the display priority information and the displayable area information, items of UI window information. The remote control window in which the items of UI window information are laid out in the determined layout is displayed.

### BACKGROUND OF THE INVENTION

1. Field of the Invention

The present invention relates to a remote control system which causes a remote control terminal to operate a controlled apparatus via a network, and a method of controlling the same.

2. Description of the Related Art

The recent progress of network technologies enables remote access using a public network not only to a general personal computer but also to a mobile terminal or an apparatus dedicated to a specific work such as a semiconductor manufacturing apparatus. The remote access technique implements various kinds of applications. For example, it allows a user to download software of the latest version via a communication line and immediately use it. It is also possible to perform timely examination or correction of an apparatus dedicated to a specific task by round-the-clock remote maintenance without sending any service person. Alternatively, apparatus parameters can be adjusted without sending any service person to the installation site of the apparatus.

However, to remote-control an apparatus dedicated to a specific task, it is necessary to cause a single remote control terminal to monitor the operation states of a plurality of controlled apparatuses and remote-control them. For this purpose, the control windows of the plurality of controlled apparatuses must be displayed dynamically.

Japanese Patent Laid-Open No. 11-317987 discloses a technique of causing a controlled apparatus to hold UI window information to form a window and apparatus control information and transmit these items of information to a remote control terminal, thereby dynamically forming the window of the remote control terminal.

Japanese Patent Laid-Open No. 2002-119475 discloses a technique of receiving UI window information from a plurality of apparatuses and changing the UI window layout by preferentially displaying the UI windows of apparatuses having high priority in accordance with the pre-defined priority order of the apparatuses.

According to these conventional techniques, it is possible to provide a control window corresponding to the status of a controlled device to a user.

However, when remote-controlling an apparatus dedicated to a specific task, the user's monitor/control target changes depending on processes in which the apparatus is used. Take, for example, remote control of a semiconductor exposure apparatus. A semiconductor exposure apparatus is used in various processes such as a development process of determining optimum control parameters and a volume production process of exposing wafers in accordance with the determined parameters. In the development process, the user must monitor/control the action of the semiconductor exposure apparatus based on control parameters set by the user himself/herself. However, in the volume production process, it is necessary to monitor whether the fabrication line has not stopped due to an error. Accordingly, the user's monitor/control target changes depending on processes.

As described above, the techniques described in Japanese Patent Laid-Open Nos. 11-317987 and 2002-119475 allows dynamic display of the control window of a controlled apparatus. In these techniques, however, when a plurality of controlled apparatuses exist, the control windows are laid out in accordance with the pre-defined priorities of the apparatuses. The control windows or layout cannot be changed in accordance with the process when a plurality of apparatuses is used.

### SUMMARY OF THE INVENTION

The present invention has been made in consideration of the above-described problem, and has as its object to provide a remote control system capable of changing the control window layout in accordance with a process where a controlled apparatus is used, and a method of controlling the same.

According to one aspect of the present invention, a remote control system capable of changing the control window layout in accordance with a process where a controlled apparatus is used is provided. The controlled apparatus includes a management unit which manages the apparatus status of the controlled apparatus, and a generation unit which generates UI window candidate information. A remote control terminal acquires display priority information of each apparatus status, and displayable area information of the remote control window. The remote control terminal receives the UI window candidate information and determines, based on the display priority information and the displayable area information, items of UI window information. The remote control window in which the items of UI window information are laid out in the determined layout is displayed.

Further features of the present invention will become apparent from the following description of exemplary embodiments with reference to the attached drawings.

### BRIEF DESCRIPTION OF THE DRAWINGS

FIG. 1 is a block diagram showing the arrangement of a remote control system according to an embodiment of the present invention;

FIG. 2 is a block diagram showing the arrangement of a semiconductor exposure apparatus according to the first embodiment of the present invention;

FIG. 3 is a block diagram showing the arrangement of a remote control terminal apparatus according to the first embodiment of the present invention;

FIG. 4 is a flowchart illustrating the processing procedure of the remote control terminal apparatus and the semiconductor exposure apparatus according to the first embodiment of the present invention;

FIG. 5 is a view for explaining the layout pattern of UI window information on a remote control window according to the first embodiment of the present invention;

FIG. 6 is a view showing an example of the data structure of UI window candidate information according to the second embodiment of the present invention;

FIG. 7 is a view for explaining displayable area information according to the first embodiment of the present invention;

FIG. 8 is a view for explaining display priority information according to the first embodiment of the present invention;

FIG. 9 is a flowchart illustrating processing of determining items of UI window information to be displayed and their layout according to the first embodiment of the present invention;

FIG. 10 is a block diagram showing the functional arrangement of the semiconductor exposure apparatus and the remote control terminal apparatus according to the first embodiment of the present invention;

FIG. 11 is a flowchart for explaining a UI window layout changing method upon a change in the apparatus status according to the first embodiment of the present invention;

FIG. 12 is a block diagram showing the arrangement of a semiconductor exposure apparatus according to the second embodiment of the present invention;

FIG. 13 is a block diagram showing the arrangement of a remote control terminal apparatus according to the second embodiment of the present invention;

FIG. 14 is a block diagram showing the functional arrangement of the semiconductor exposure apparatus and the remote control terminal apparatus according to the second embodiment of the present invention;

FIG. 15 is a flowchart illustrating the processing procedure of the remote control terminal apparatus and the semiconductor exposure apparatus according to the second embodiment of the present invention;

FIG. 16 is a view showing an example of job information according to the second embodiment of the present invention;

FIGS. 17A and 17B are a view showing an example of job display priority information according to the second embodiment of the present invention;

FIG. 18 is a flowchart illustrating a UI window layout changing method upon a change in the job of an apparatus according to the second embodiment of the present invention;

FIG. 19 is a flowchart illustrating processing of determining items of UI window information to be displayed and their layout according to the second embodiment of the present invention;

FIG. 20 is a flowchart for explaining details of UI window candidate information layout enable/disable state determination processing according to the first embodiment of the present invention; and

FIG. 21 is a view for explaining the coordinate system of a displayable area according to an embodiment.

### DESCRIPTION OF THE EMBODIMENTS

Various exemplary embodiments, features, and aspects of the present invention will be described in detail below with reference to the drawings.

### First Embodiment

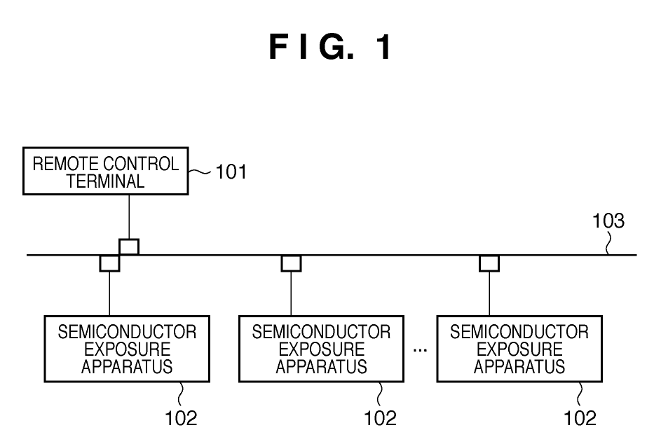

FIG. 1 is a block diagram showing the arrangement of a remote control system according to this embodiment.

A remote control terminal apparatus 101 serves as a host computer which accommodates an online system in a factory. The remote control terminal apparatus 101 is connected to a plurality of semiconductor exposure apparatuses 102 serving as controlled apparatuses in the factory using the SECS or HSMS protocol. FIG. 1 illustrates three semiconductor exposure apparatuses 102. This is merely an example, and the present invention is not limited to a specific number. The online control/monitor system of the plurality of semiconductor exposure apparatuses 102 is accommodated in the remote control terminal apparatus 101 via a communication line 103. The communication line 103 is laid for LAN communication in the factory. The communication line 103 is typically implemented using Ethernet® and formed from, for example, 10BASE-2/5 using a coaxial cable or star-connected 10BASE-T using a twisted-pair line. Communication between the remote control terminal apparatus 101 and the plurality of semiconductor exposure apparatuses 102 via the communication line 103 can be done using, for example, the HSMS protocol using TCP/IP as a lower-layer protocol. In Ethernet®, generally, simultaneous transmission/reception is often performed using a protocol other than TCP/IP.

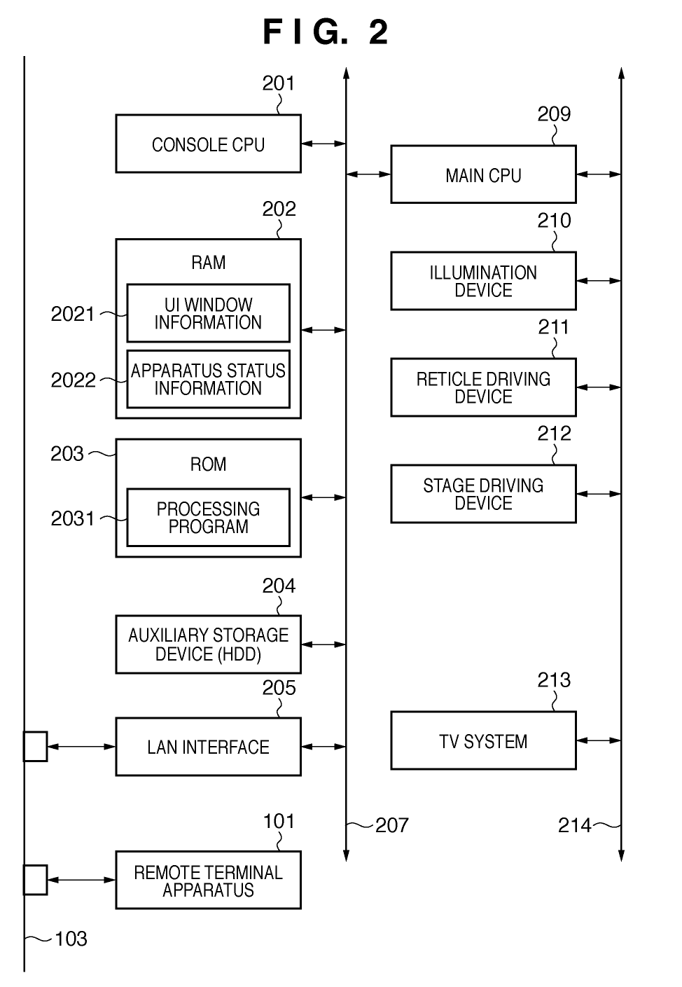

FIG. 2 shows the hardware configuration of the semiconductor exposure apparatus 102.

A console CPU 201 controls the console window display on the semiconductor exposure apparatus and its operation using a console panel. A RAM 202 stores data and programs to be executed by the console CPU 201. In this embodiment, the RAM 202 particularly stores UI window information 2021 and apparatus status information 2022.

A ROM 203 stores programs and, more particularly, a processing program 2031.

An auxiliary storage device 204 is formed from, for example, a hard disk drive (HDD) which stores data and programs. A LAN interface 205 using various standards such as 10BASES, 10BASE2, and 10BASE-T is used to connect the communication line 103.

A main CPU 209 comprehensively controls various control devices of the semiconductor exposure apparatus. An illumination device 210 controls a light source to expose a wafer for semiconductor manufacture. A reticle driving device 211 controls load/unload of a reticle (photomask) having a pattern to be exposed on a wafer for semiconductor manufacture. A stage driving device 212 controls driving of a wafer for semiconductor manufacture on an X-Y stage to expose the wafer by a step-and-repeat method. An alignment TV system 213 controls and accurately aligns a wafer for semiconductor manufacture. The devices 210, 211, 212, and 213 are controlled by the main CPU 209 via a peripheral device bus 214. The peripheral device bus 214 can use a general-purpose standard bus as represented by SCSI.

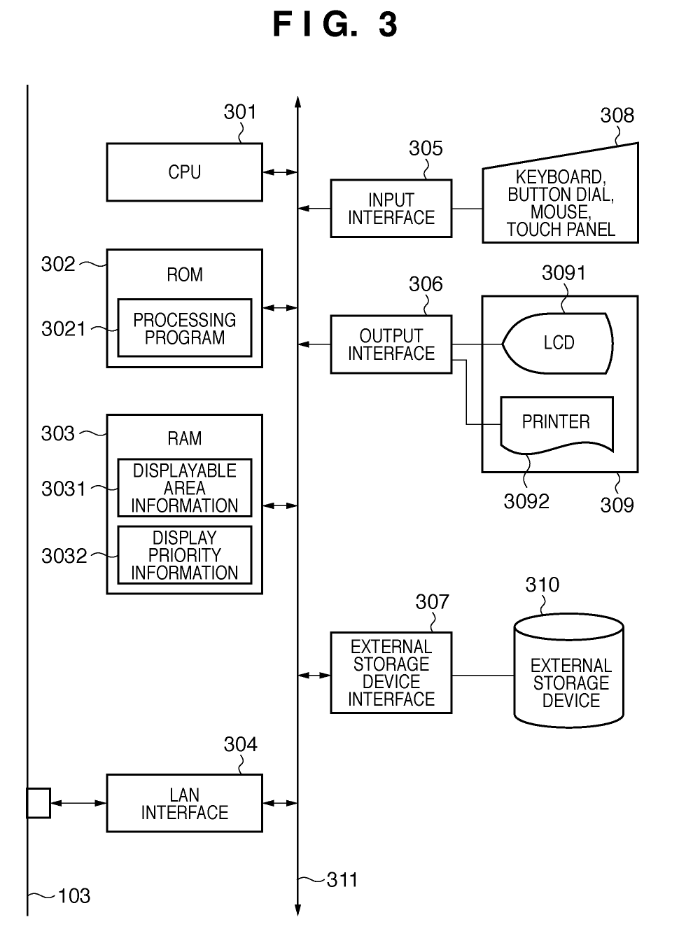

FIG. 3 is a block diagram showing the hardware configuration of the remote control terminal apparatus 101.

A CPU 301 accesses and controls constituent elements 302-310 (to be described below) via a bus 311.

The read only memory (ROM) 302 is accessible by the CPU 301 via the bus 311 and stores a processing program 3021 whose operation will be explained in detail in this embodiment. The random access memory (RAM) 303 stores displayable area information 3031 and display priority information 3032 generated by executing the processing program 3021 in this embodiment.

A LAN interface 304 is used to connect the communication line 103. An input interface 305 receives inputs via an input device 308 such as a keyboard, mouse, or tablet. An output interface 306 displays or outputs data on or to an output device 309 implemented by an LCD 3091 or a printer 3092. The external storage device interface 307 receives or outputs data from or to an external storage device 310 such as an HD, FD, CD-ROM, MD, or CF.

In this embodiment, a description will be made assuming that the processing program 3021 is stored in the ROM 302, and the displayable area information 3031 and display priority information 3032 is stored in the RAM 303. All the items of information can also be stored in the external storage device 310, and loaded from the external storage device 310 to the RAM 303 as needed. It is also possible to store the items of information in the cache memory (not shown) of the CPU 301.

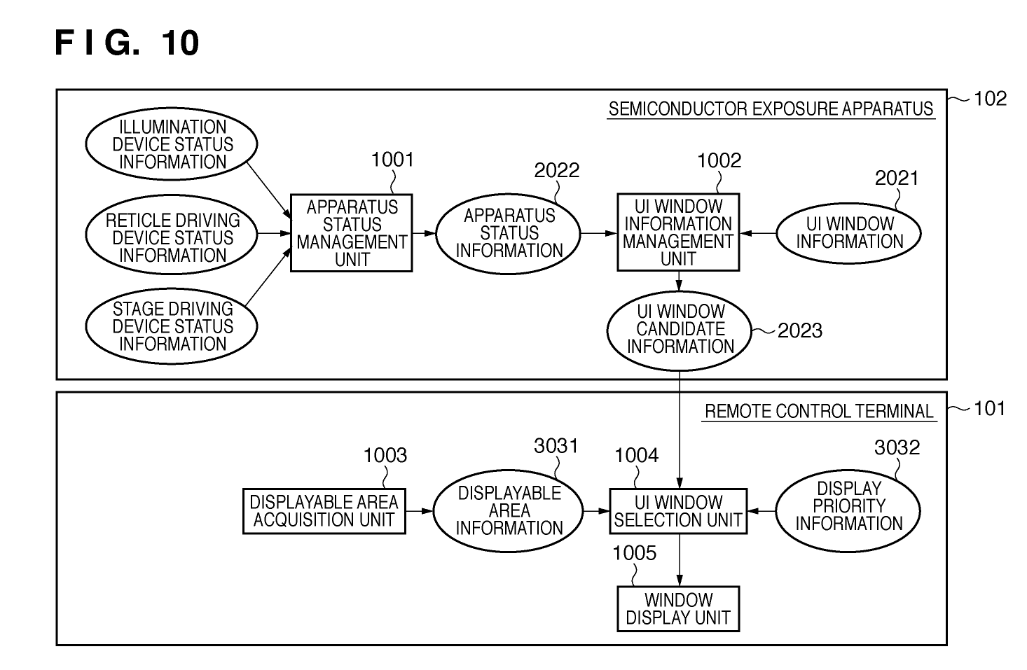

FIG. 10 is a block diagram showing the functional arrangement of the semiconductor exposure apparatus 102 and the remote control terminal apparatus 101.

An apparatus status management unit 1001 manages the devices (illumination device 210, reticle driving device 211, and stage driving device 212) included in the semiconductor exposure apparatus 102, and generates the apparatus status information 2022 indicating the apparatus status of the semiconductor exposure apparatus 102 based on the status information of each device.

A UI window information management unit 1002 manages the UI window information 2021 and apparatus status information 2022 for the operation of the semiconductor exposure apparatus 102 in association with each other, and generates UI window candidate information 2023 for each apparatus status in accordance with a request from the remote control terminal apparatus 101.

A displayable area acquisition unit 1003 generates the displayable area information 3031 representing, in the display area of the remote control terminal apparatus 101, an area capable of displaying a UI window for remote control.

A UI window selection unit 1004 determines items of UI window information to be displayed and their layout and generates a display window based on the display priority information 3032 which defines the display priority for each apparatus status, the displayable area information 3031, and the UI window candidate information 2023 for each apparatus status.

A window display unit 1005 outputs the display window generated by the UI window selection unit 1004 to the LCD 3091 of the output device 309.

The contents of processing according to this embodiment will be described below in detail. The processing procedure to be described below is not limited to this embodiment. Various procedures may be combined, a plurality of processes may be put together, or a process may be divided into parts as far as the effects intended by the present invention can be obtained. Alternatively, functional elements to execute individual processes may be implemented by single components and combined.

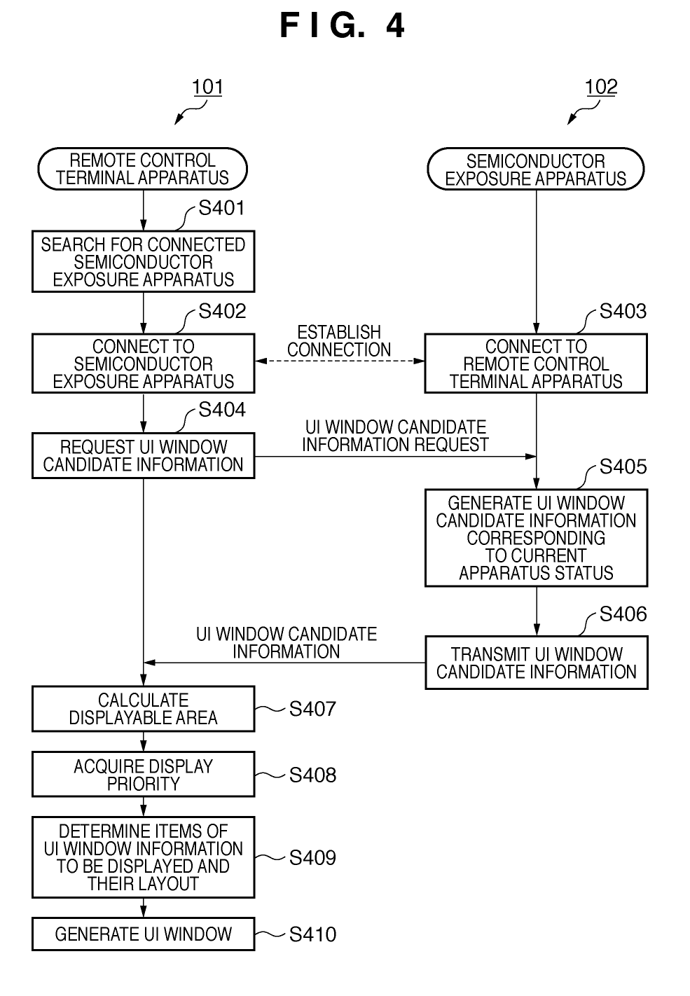

FIG. 4 is a flowchart illustrating the processing procedure of the remote control terminal apparatus 101 and the semiconductor exposure apparatus 102 according to this embodiment until a UI window is generated using the remote control terminal apparatus 101.

After powering on the remote control terminal apparatus 101, the process advances to step S401 to display a remote control UI window.

In step S401, a search for a semiconductor exposure apparatus connected via the communication line 103 is done. The search can be done either by IP-broadcasting data and specifying a semiconductor exposure apparatus that has returned a response, or by inquiring of a directory server database such as LDAP about a semiconductor exposure apparatus connected to the network. When the search ends, the process advances to step S402.

In step S402, if a plurality of semiconductor exposure apparatuses are found in step S401, a semiconductor exposure apparatus is selected as a remote control target, and the remote control terminal apparatus 101 is connected to the selected semiconductor exposure apparatus 102. At this time, the remote control terminal apparatus 101 can automatically be connected to all the semiconductor exposure apparatuses 102 found in step S401. Alternatively, a search result list may be displayed to cause the user to select one of the semiconductor exposure apparatuses.

In step S403, the semiconductor exposure apparatus 102, which has received the connection request, performs connection processing for the remote control terminal apparatus 101 so that connection between the remote control terminal apparatus 101 and the semiconductor exposure apparatus 102 is established.

In step S404, the remote control terminal apparatus 101 requests UI window candidate information of the semiconductor exposure apparatus 102.

In step S405, the semiconductor exposure apparatus 102 generates the UI window candidate information 2023 in accordance with the apparatus status (operative state). The UI window candidate information will be described in detail later. In step S406, the semiconductor exposure apparatus 102 transmits the UI window candidate information generated in step S405 to the remote control terminal apparatus 101.

In step S407, the remote control terminal apparatus 101 calculates the displayable area information of the LCD 3091 via the output interface 306. In step S408, the remote control terminal apparatus 101 acquires display priority information. In step S409, the remote control terminal apparatus 101 receives the UI window candidate information transmitted in step S406. The remote control terminal apparatus 101 determines, out of the received UI window candidate information, items of UI window information to be displayed and their layout based on the displayable area information acquired in step S407 and the display priority information acquired in step S408. The UI window information and the layout method will be described in detail later.

In step S410, the remote control terminal apparatus 101 generates a remote control window (UI window) including the items of UI window information laid out in the determined layout and displays it on the LCD 3091.

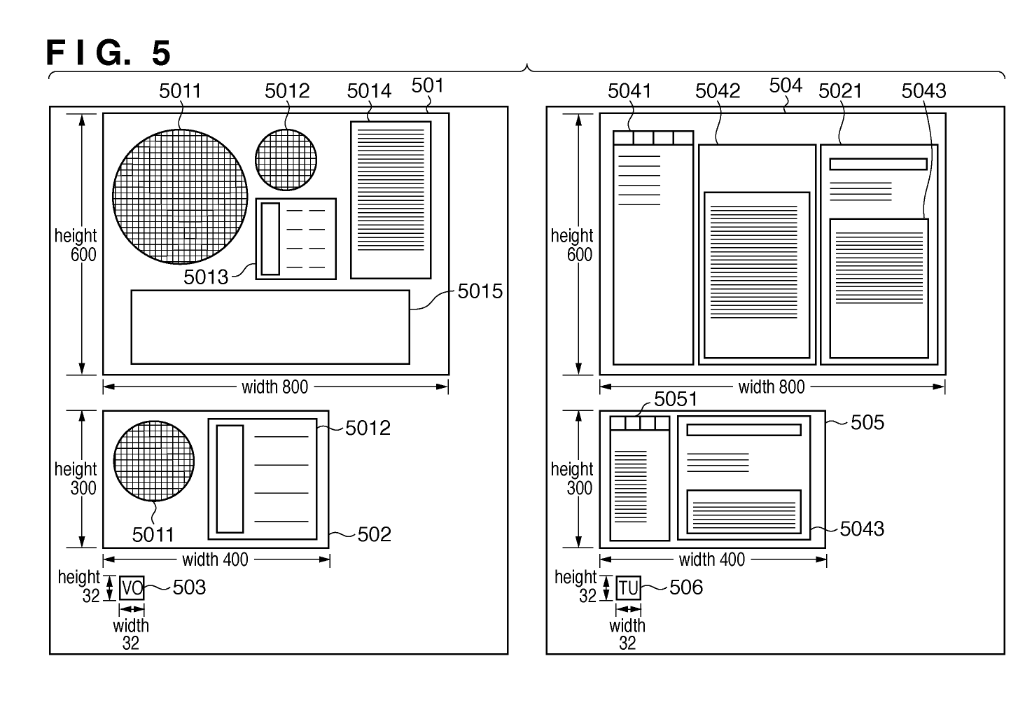

FIG. 5 is a view for explaining the layout pattern of UI window information on the UI window.

Reference numerals 501, 502, and 503 denote examples of UI windows that display the exposure state in volume semiconductor production by the semiconductor exposure apparatus 102. As shown in FIG. 5, the UI windows 501, 502, and 503 have different display sizes and different types of information displayed.

Reference numerals 504, 505, and 506 denote examples of UI windows for the parameter adjustment operation in tuning the semiconductor exposure apparatus 102. As shown in FIG. 5, the UI windows 504, 505, and 506 have different sizes and types of UI window information displayed.

UI window information is formed by, for example, Java® and installed using a Jar (Java ARchive) file, which is an archive file format. Each item of UI window information includes a plurality of GUI components such as buttons, scroll bars, and list boxes, and a logic portion which notifies the semiconductor exposure apparatus 102 of an interaction input to each GUI component by a user operation. Each of the GUI components and logic portion holds height and width information corresponding to the minimum necessary vertical and horizontal size information for display.

The UI window 501 is displayed in a large display area at the time of volume production. In the UI window 501, a GUI component 5011 virtually displays the exposure state of a wafer which is being exposed on the first wafer stage. For example, the center of the circle is defined as the center of the wafer. The position of the wafer is represented by coordinates from the center. The exposure state or result of the wafer is expressed by a color such as blue or red. A GUI component 5012 displays a wafer which is undergoing parameter adjustment on the second wafer stage. The display form is the same as the GUI component 5011. A GUI component 5013 displays information complementing the display in the GUI components 5011 and 5012. The GUI component 5013 displays an explanation of exposure states and results corresponding to display colors. For example, “red” indicates “exposure failure”, and “blue” indicates “normal exposure”. A GUI component 5014 displays information of each exposure job, including a job ID, executor name, control parameter setting file, and job start and end times. A GUI component 5015 displays a detailed operation log of exposure.

The UI window 502 is displayed in a display area smaller than the UI window 501. The UI window 502 has a small display area and can output no detailed operation log. Hence, the UI window 502 includes only the GUI components 5011 and 5012 to display only the exposure state of the wafer which is being currently exposed for the user.

The UI window 503 is displayed in a display area smaller than the UI window 502. The UI window 503 includes an icon component which represents only that the semiconductor exposure apparatus 102 is currently operating in the volume production process. The icon component indicates a state by a color by using, for example, “blue” for “normal operation”, “yellow” for “automatically recoverable error”, and “red” for “fatal error that is recoverable only manually”.

The UI window 504 is displayed in a large display area when tuning the semiconductor exposure apparatus 102. In the UI window 504, a GUI component 5041 displays the list of parameters to be adjusted in tuning. The GUI component 5041 includes tabs to select a parameter setting target such as a wafer, reticle, or command. When the user selects a tab, the indices of settable parameters are displayed so that the user can select indices. A GUI component 5042 displays the list of parameters of the indices selected in the GUI component 5041, in which the user can select each parameter. A GUI component 5043 allows the user to input details of the parameters selected in the GUI component 5042. The remote control terminal apparatus 101 can send the input and set parameters to the semiconductor exposure apparatus 102 and receive a response. Normally, the user repeats the operation of setting the parameters and checking the response from the semiconductor exposure apparatus 102, thereby determining optimum parameters.

The UI window 505 is UI window information displayed in a display area smaller than the UI window 504. The UI window 505 includes a GUI component 5051 and the GUI component 5043. The GUI component 5051 displays the list of parameters to be adjusted in tuning. The GUI component 5051 includes tabs to select a parameter setting target such as a wafer, reticle, or command. When the user selects a tab, details of settable parameters are displayed so that the user can select parameters. The GUI component 5043 is the same as in the UI window 504.

The UI window 506 is smaller than the UI window 505. The UI window 506 includes an icon component which indicates only that the semiconductor exposure apparatus 102 is currently operating in the tuning process.

The processing of causing the remote control terminal apparatus 101 to determine items of UI window information to be displayed and their layout in step S409 will be described in detail next.

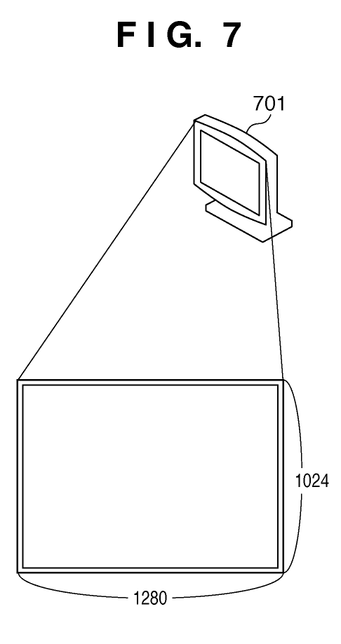

FIG. 7 is a view showing the display screen of the LCD 3091 connected to the output interface 306 of the remote control terminal apparatus 101. Reference numeral 701 represents that the full screen of the LCD 3091 of the remote control terminal apparatus 101, which has a resolution of, for example, 1280×1024, is usable as the remote control window of the semiconductor exposure apparatus 102.

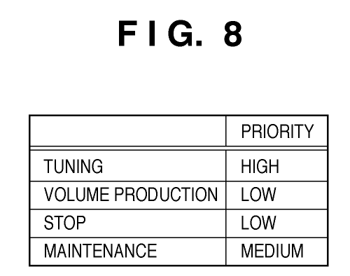

FIG. 8 is a view for explaining display priority information. Each row represents a status of the apparatus, and the column represents the priority levels of the respective statuses. Referring to FIG. 8, “tuning” represents a state in which the semiconductor exposure apparatus 102 is being operated while the control parameters are being adjusted to set optimum control parameters before volume production. “Volume production” represents a state in which the control parameters of the semiconductor exposure apparatus 102 have been set, and volume semiconductor production is in progress. “Stop” represents a state in which the semiconductor exposure apparatus 102 is not operating because of the absence of jobs to be executed. “Maintenance” represents a state in which periodic basic performance confirmation and adjustment, exchange of expendables, troubleshooting, and the like are being executed.

Assume that the user has the following desires.

(1) Detailed information is necessary to monitor the operation of a semiconductor exposure apparatus during control parameter adjustment.

(2) Only rough information indicating, for example, the presence/absence of an error is necessary for a semiconductor exposure apparatus which is operating stably.

(3) For a semiconductor exposure apparatus in a stopped state, only the status “stopped” needs to be found. In this case, the priority is set in the order of tuning>maintenance>volume production=stop, as shown in FIG. 8.

In this embodiment, the remote control terminal apparatus 101 holds display priority information. However, the semiconductor exposure apparatus 102 may hold the pre-defined display priority information of the apparatus. In that case, the remote control terminal apparatus 101 may acquire and use the display priority information. Alternatively, the display priority information may be loaded from the semiconductor exposure apparatus 102, partially changed by the user, and overwritten.

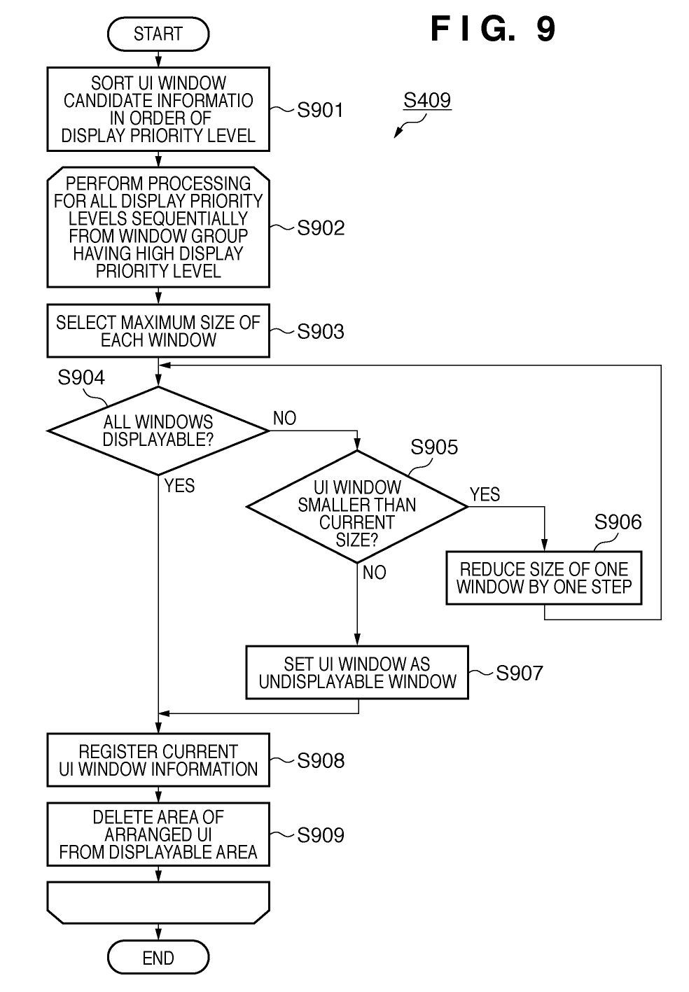

FIG. 9 is a flowchart illustrating processing of determining items of UI window information to be displayed and their layout in step S409.

In step S901, the remote control terminal apparatus 101 sorts items of UI window candidate information received in step S406 in accordance with the display priority order acquired in step S408, and puts the items of UI window candidate information into groups each corresponding to a display priority level.

As shown in step S902, processing in step S903 to S909 is performed sequentially from a window group having a high display priority level.

In step S903, the width and height of each window are set to display a maximum one of the items of UI window candidate information of the current display priority level. In step S904, it is determined on the basis of the set width and height whether each UI window candidate information can be laid out in the displayable area. If UI window candidate information cannot fit in the displayable area, the process advances to step S905. The layout enable/disable state determination processing in step S904 will be described in detail later.

In step S905, it is determined whether a UI window smaller than the width and height currently set in the UI window candidate information exists. If a smaller UI window exists, the process advances to step S906. If no smaller UI window exists, the process advances to step S907.

In step S906, the currently set width and height are changed to those of the UI window smaller by one step. The process returns to step S904.

In step S907, the UI window is set as an undisplayable window.

In step S908, the currently set UI window is registered as a UI window to be requested of the semiconductor exposure apparatus 102. In step S909, the area occupied by the set UI window is deleted from the displayable area.

When the processing in steps S903 to S909 is performed for the UI window candidate information groups of all display priority levels, items of necessary UI window information and the window layout are determined. A dialogue is displayed to notify the user that the UI window was set as an undisplayable window in step S907.

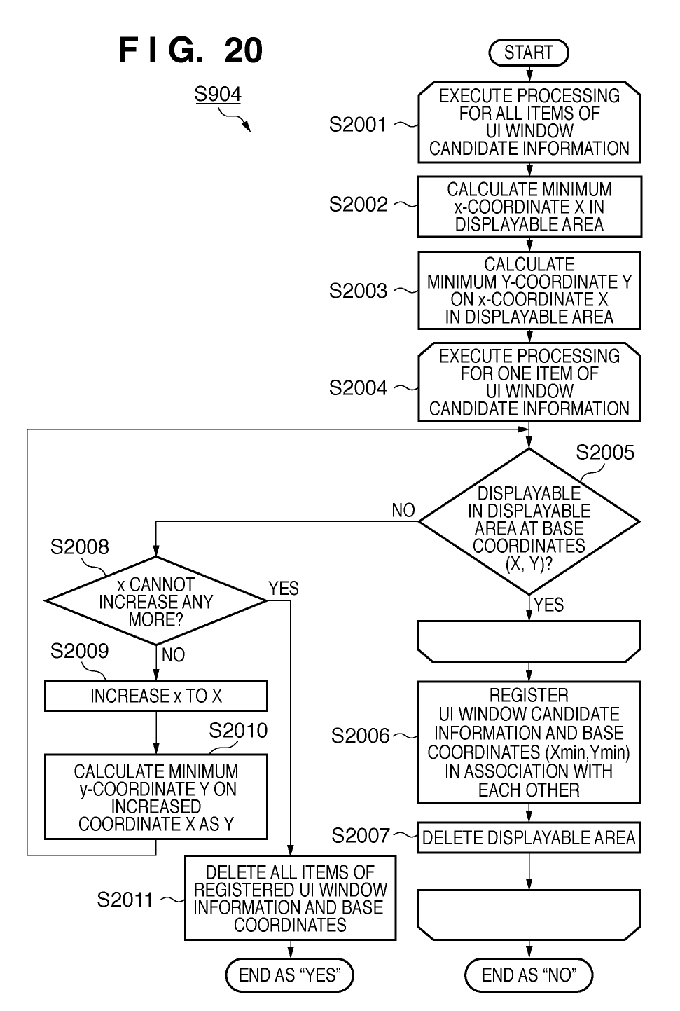

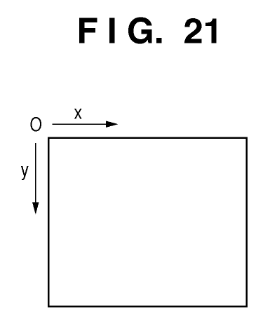

FIG. 20 is a flowchart for explaining details of the UI window candidate information layout enable/disable state determination processing in step S904. An explanation will be made here using a coordinate system having its origin at the upper left corner of a displayable area, an X-axis in the horizontal direction, and a Y-axis in the vertical direction, as shown in FIG. 21.

As shown in step S2001, processing from step S2002 is executed for all items of UI window candidate information which have the same display priority and are put into a group in step S902.

In step S2002, a minimum x-coordinate value X in the displayable area is calculated. In step S2003, a minimum y-coordinate value Y on the x-coordinate X calculated in step S2002 is calculated.

From step S2004, coordinates at which UI window candidate information can be laid out are calculated. In step S2005, it is determined whether UI window candidate information can be laid out at the base coordinates (X, Y) calculated in steps S2002 and S2003. If the UI window candidate information can be laid out, the process advances to step S2006 to register the current base coordinates (X, Y) and the UI window candidate information in association with each other. In step S2007, the area of the UI window candidate information laid out in step S2006 is deleted from the displayable area.

If the processing up to step S2007 is ended for all items of UI window candidate information, the processing ends with a “YES” (i.e., all windows can be laid out) because the base coordinates to display all items of UI window candidate information are determined.

If the UI window candidate information cannot be laid out at the coordinates (X, Y) in step S2005, the process advances to step S2008. In step S2008, it is determined whether the coordinate value X exceeds the width of the displayable area upon increment. If the coordinate value X does not exceed the width, the process advances to step S2009. In step S2009, the value X is incremented to replace the current value X. The increment value may be 1 or a specific value such as 10 to 100. In step S2010, the minimum y-coordinate Y on the x-coordinate X is calculated to replace the base coordinate Y. The processing in step S2005 is repeated using the replaced coordinates (X, Y).

If the coordinate X exceeds the width of the displayable area in step S2008, it is determined that the UI window candidate information of the current size cannot be laid out in the displayable area, and the process advances to step S2011. In step S2011, all the base coordinates and UI window candidate information registered in step S2007 are deleted. The processing ends with a “NO” (i.e., not all windows can be laid out).

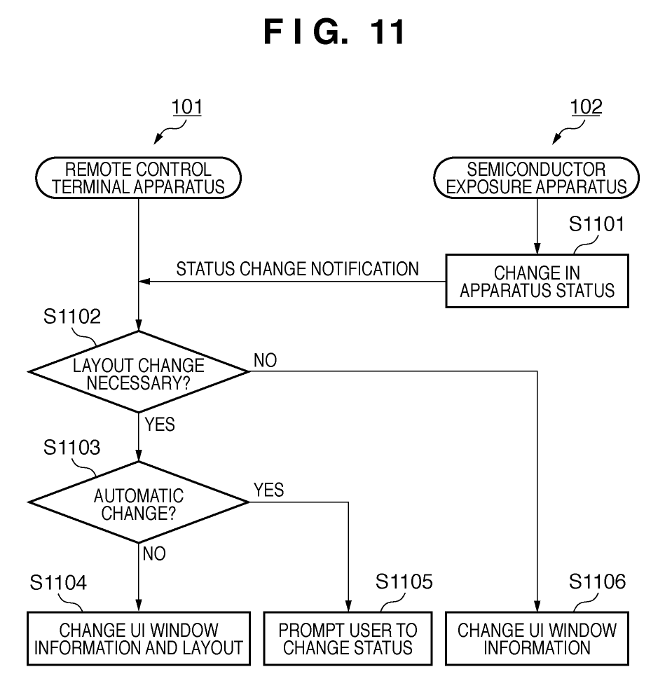

FIG. 11 is a flowchart for explaining layout change processing when the status of the semiconductor exposure apparatus 102 is changed by an operation of another user or termination of processing.

In step S1101, the semiconductor exposure apparatus 102 notifies the remote control terminal apparatus 101 that the apparatus status has changed.

Upon receiving the status change notification sent in step S1101, the remote control terminal apparatus 101 compares the changed status with the status priority and determines whether a layout change is necessary in step S1102. If a layout change is necessary, the process advances to step S1103. The user sets in advance whether to change the layout automatically or manually. If it is determined in step S1103 in accordance with the setting that the layout is to be changed automatically, the process advances to step S1104. To change the layout manually, the process advances to step S1105.

In step S1104, the remote control terminal apparatus 101 changes the layout in the same way as in step S409. In step S1105, the remote control terminal apparatus 101 notifies the user of the status change using the display area before the change without changing the layout. To do this, a dialog may be displayed. Alternatively, the frame of the area may be highlighted or blinked.

If no layout change is necessary in step S1102, only the UI window information is changed in step S1106.

According to the above-described first embodiment, it is possible to provide an optimum remote control window corresponding to the apparatus status of the semiconductor exposure apparatus.

### Second Embodiment

The second embodiment is different from the first embodiment in the UI window information communication method and the display priority setting method. The second embodiment of the present invention will be described below mainly regarding the difference from the first embodiment.

A network system according to the second embodiment has the same arrangement as that of the first embodiment shown in FIG. 1.

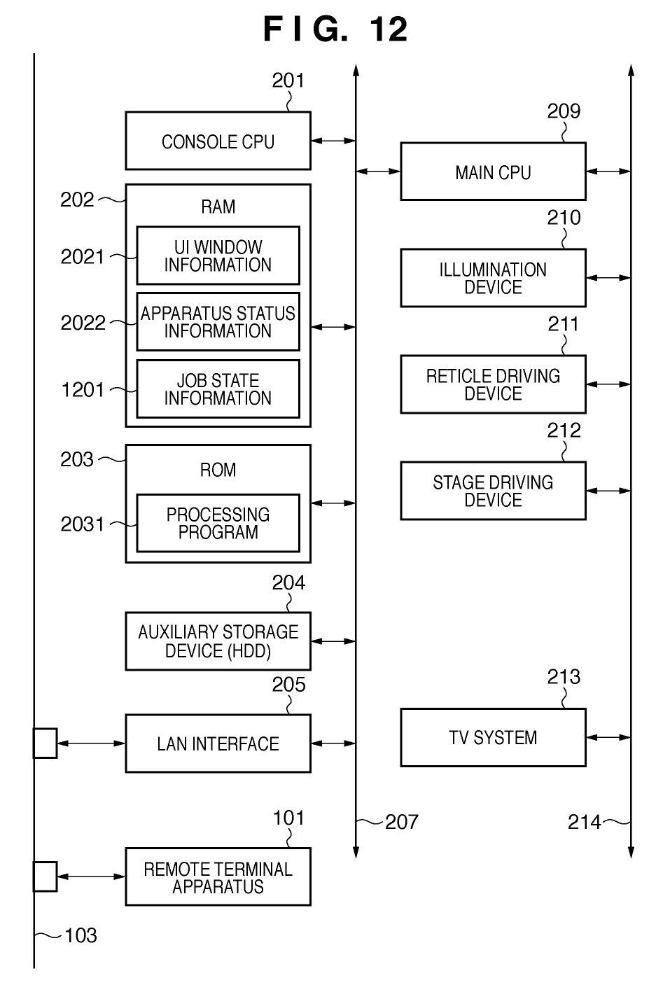

FIG. 12 is a block diagram showing the hardware configuration of a semiconductor exposure apparatus 102 according to the second embodiment. The same reference numerals as in FIG. 2 denote the same constituent elements. In this embodiment, job state information 1201 is added to a RAM 202, as shown in FIG. 12. The remaining constituent elements are the same as in FIG. 2.

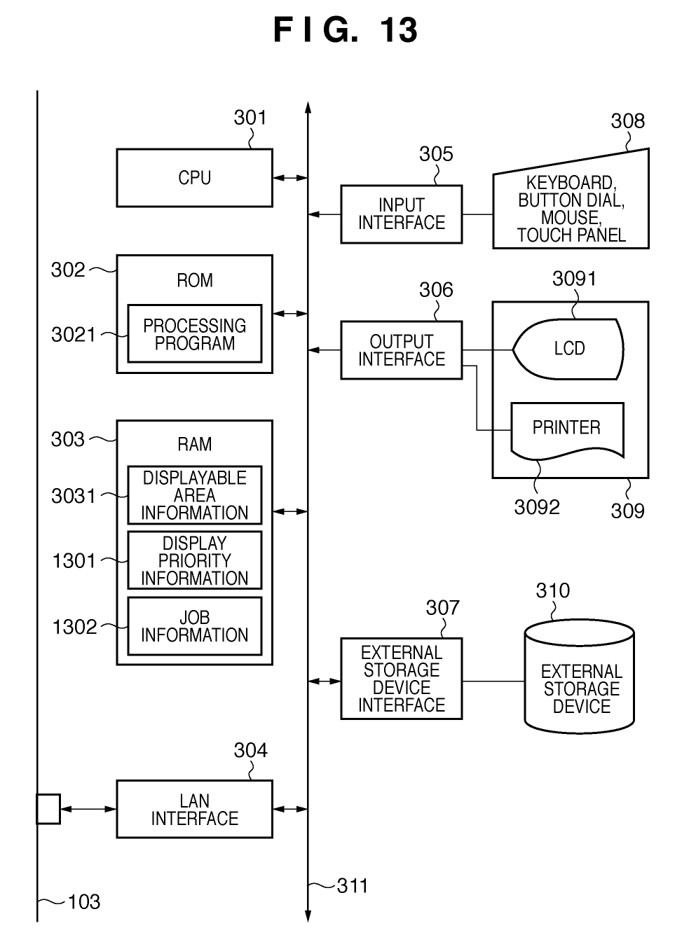

FIG. 13 is a block diagram showing the hardware configuration of a remote control terminal apparatus 101 according to the second embodiment. The same reference numerals as in FIG. 3 denote the same constituent elements. Referring to FIG. 13, display priority information 1301 represents a display priority corresponding to a job state. Job information 1302 represents the state of a job which is being executed. The remaining constituent elements are the same as in FIG. 3.

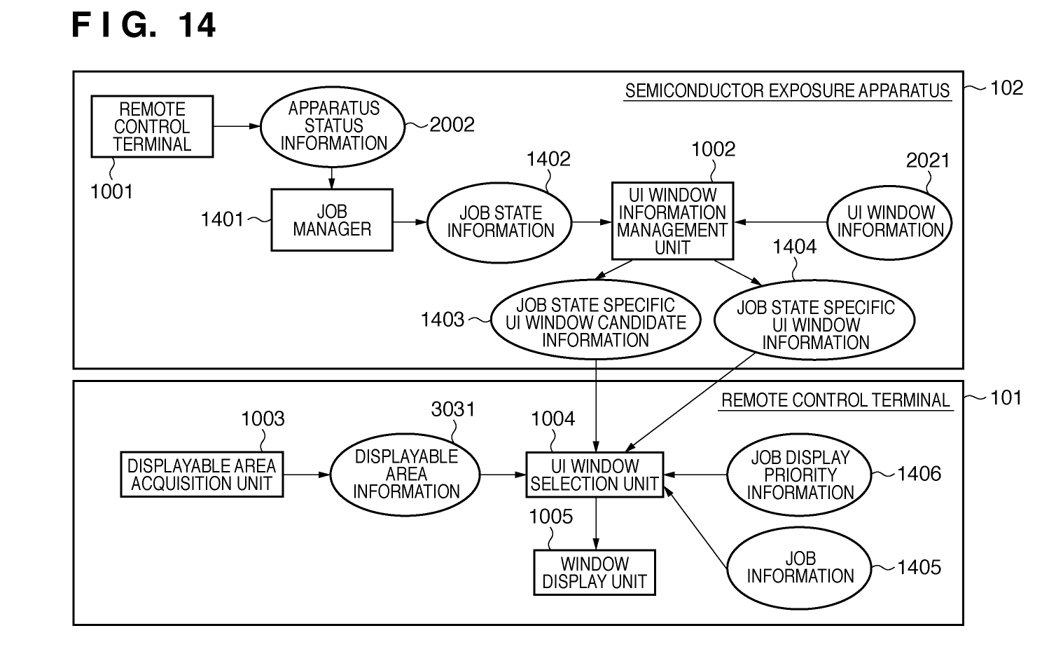

FIG. 14 is a block diagram showing the functional arrangement of the semiconductor exposure apparatus 102 and the remote control terminal apparatus 101 according to the second embodiment. The same reference numerals as in FIG. 10 denote the same constituent elements. Referring to FIG. 14, reference numeral 1401 denotes a job manager. The job manager 1401 manages apparatus status information 2022 indicating statuses from devices (illumination device 210, reticle driving device 211, and stage driving device 212) included in the semiconductor exposure apparatus 102 in association with the information of a job which is being executed by the semiconductor exposure apparatus 102. The job manager 1401 generates job state information 1402 representing a process which is progressing.

Job state specific UI window candidate information 1403 represents a list of UI window information to be displayed in accordance with the job state. UI window information 1404 is displayed in accordance with the job state. Job information 1405 represents a job which is being executed by a semiconductor exposure apparatus connected to the network.

The processing according to this embodiment will be described below in detail The processing procedure is not limited to this embodiment. Various procedures may be combined, a plurality of processes may be put together, or a process may be divided into parts provided that the effects intended by the present invention can be obtained. Alternatively, functional elements to execute individual processes may be implemented by single components and combined.

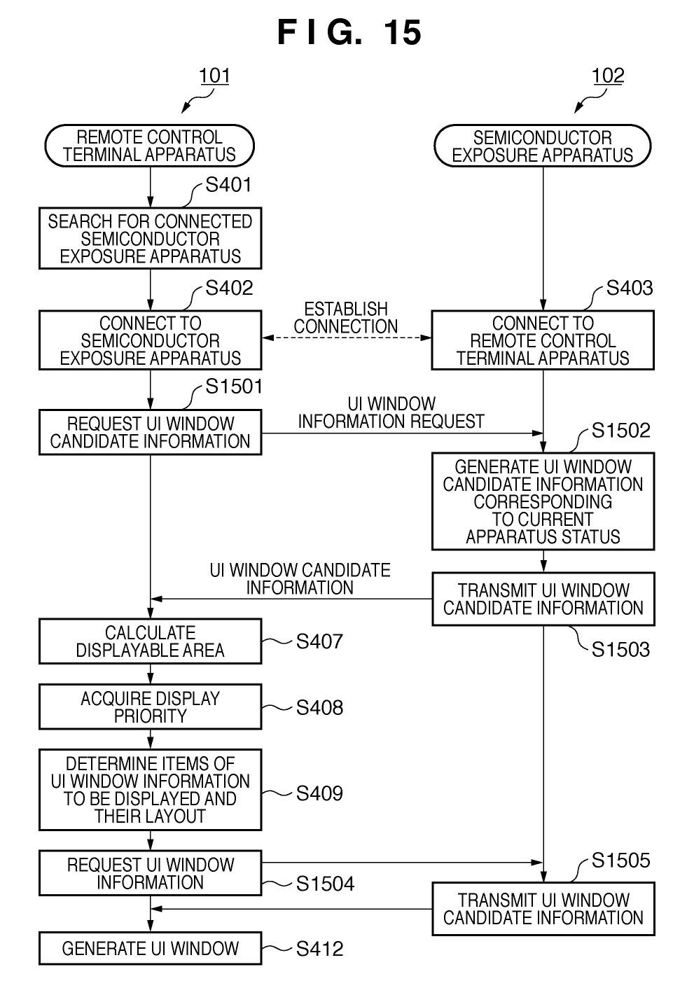

FIG. 15 is a flowchart illustrating the processing procedure of the remote control terminal apparatus 101 and the semiconductor exposure apparatus 102 according to this embodiment until a UI window is generated using the remote control terminal apparatus 101. The same step numbers as in FIG. 4 denote the same processing blocks in FIG. 15.

After powering on the remote control terminal apparatus 101, the process advances to step S401 to display a remote control UI window.

In step S401, a semiconductor exposure apparatus connected via a communication line 103 is searched. In steps S402 and S403, connection is established. Then, the process advances to step S1501.

In step S1501, the remote control terminal apparatus 101 requests UI window candidate information of the semiconductor exposure apparatus 102. In step S1502, the semiconductor exposure apparatus 102 generates the UI window candidate information in accordance with the job state. The UI window candidate information will be described in detail later. In step S1503, the semiconductor exposure apparatus 102 transmits the UI window candidate information generated in step S1502 to the remote control terminal apparatus 101.

In step S407, the remote control terminal apparatus 101 calculates the displayable area information of an LCD 3091 via an output interface 306. In step S408, the remote control terminal apparatus 101 acquires job state priority information and job information stored in an external storage device 310 connected via an external storage device interface 307. In step S409, the remote control terminal apparatus 101 receives the UI window candidate information transmitted in step S406. The remote control terminal apparatus 101 determines items of UI window information and their layout based on the displayable area information acquired in step S407 and the job state priority information and job information acquired in step S408. The job state priority information and job information will be described in detail later.

In step S1504, to load the UI window information determined in step S409 from the semiconductor exposure apparatus 102, the remote control terminal apparatus 101 issues a UI window information request to the semiconductor exposure apparatus 102. In step S1505, the semiconductor exposure apparatus 102 transmits UI window information in response to the UI window information request from the remote control terminal apparatus 101.

In step S410, the remote control terminal apparatus 101 generates a UI window based on the received UI window information and displays it on the LCD 3091. The UI window candidate information represents whether UI window information is formed to control the apparatus in its specific status.

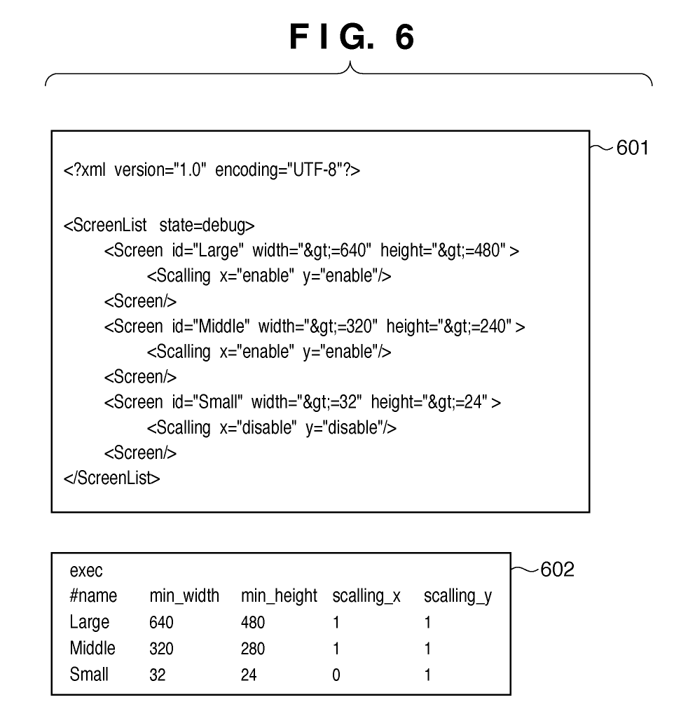

FIG. 6 is a view showing an example of the data structure of UI window candidate information.

The UI window candidate information can be expressed using the XML format as indicated by 601. A ScreenList element includes a plurality of Screen elements. Each Screen element includes an id attribute to identify a UI window, a width attribute representing the minimum necessary width of a UI window that can suitably be displayed for the user, and a height attribute representing the minimum necessary height of a UI window that can suitably be displayed for the user. Each Screen element also includes an optional Scaling attribute. This represents whether to permit scaling of the displayable area of the remote control terminal apparatus 101 in the X and Y directions when it is larger than the width and height attribute values. In this embodiment, data expressed using the XML format has been described. However, each screen may be expressed by lines, and the set values may be expressed as columns delimited by spaces, as indicated by 601. Each data may be transmitted as a packet.

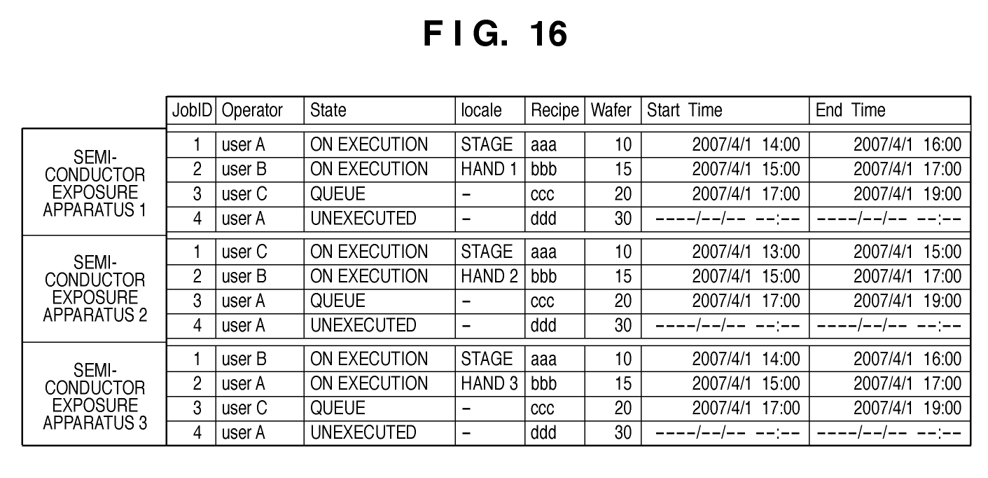

FIG. 16 is a view showing an example of job information.

FIG. 16 shows that four jobs having JobIDs 1 to 4 are registered in each of three connected semiconductor exposure apparatuses 1, 2, and 3 of the plurality of semiconductor exposure apparatuses 102. The information of each job includes Operator, State, Locale, Recipe, Wafer, StartTime, and EndTime. Operator represents the name of the operator who has performed the job issue operation. State represents the job execution state. Locale represents the location of the wafer as the exposure target of the job in the semiconductor exposure apparatus. Recipe represents details of the parameters of the job. Wafer represents the file name and wafer type. StartTime represents the start time or expected start time of the job. EndTime represents the expected end time of the job.

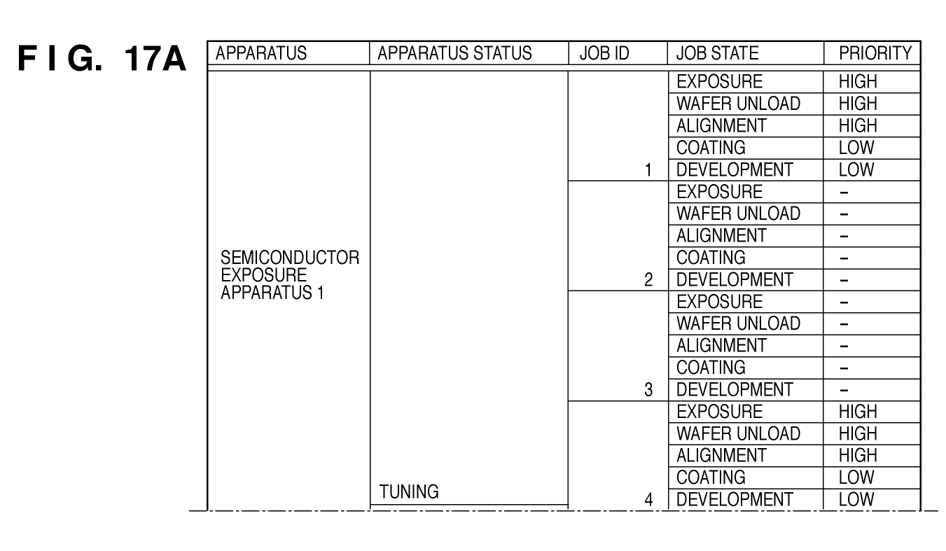

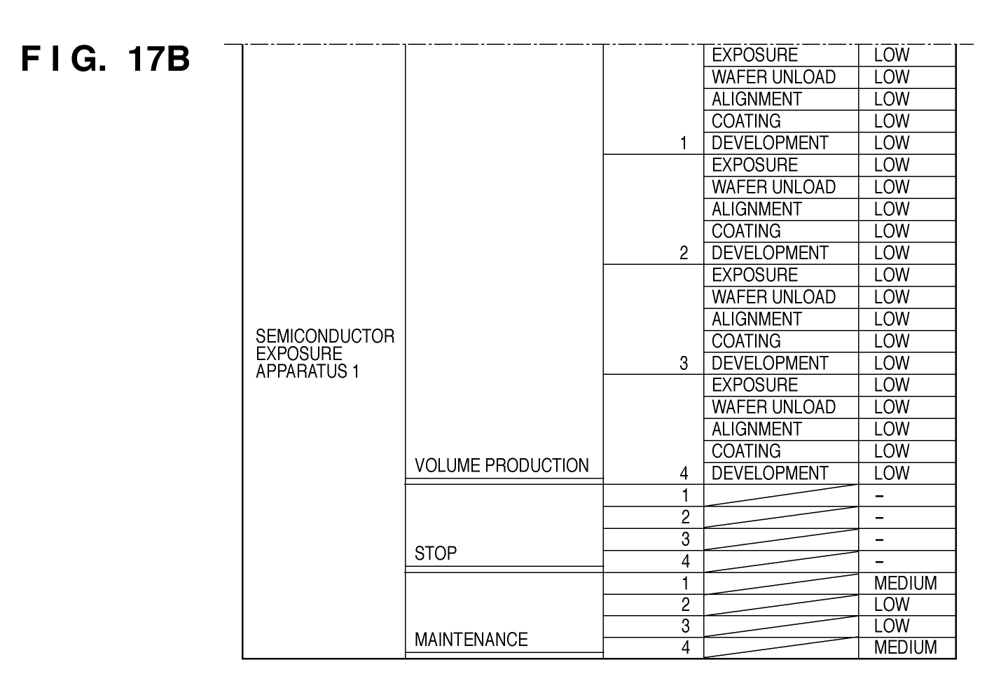

FIGS. 17A and 17B are a view showing an example of job display priority information.

FIGS. 17A and 17B show an example of settings of priorities of a control window for the semiconductor exposure apparatus 1 described in FIG. 16. The priority is determined in accordance with the apparatus status, JobID, and job state. As is apparent from the job information shown in FIG. 16, user A executes the job of JobID 1 and the job of JobID 4 in the semiconductor exposure apparatus 1. At the time of tuning, only the job of JobID 1 and the job of JobID 2 need to be seen from the remote control terminal apparatus operated by user A. The operations of the exposure process, wafer unload process, and alignment process change depending on the set parameters. As it is necessary to check the operations in more detail, the priority levels are set higher to display a more detailed UI window.

In the processes of volume production, all jobs are set to the same priority so that the user can understand all states even in a small UI window.

The user may individually set priority information for each issued job. Alternatively, the user who has logged in to the remote control terminal apparatus 101 may be compared with Operator of the job information. The display priority of a job for which the user matches Operator may automatically be set to be higher than that for a job for which the user and Operator do not match.

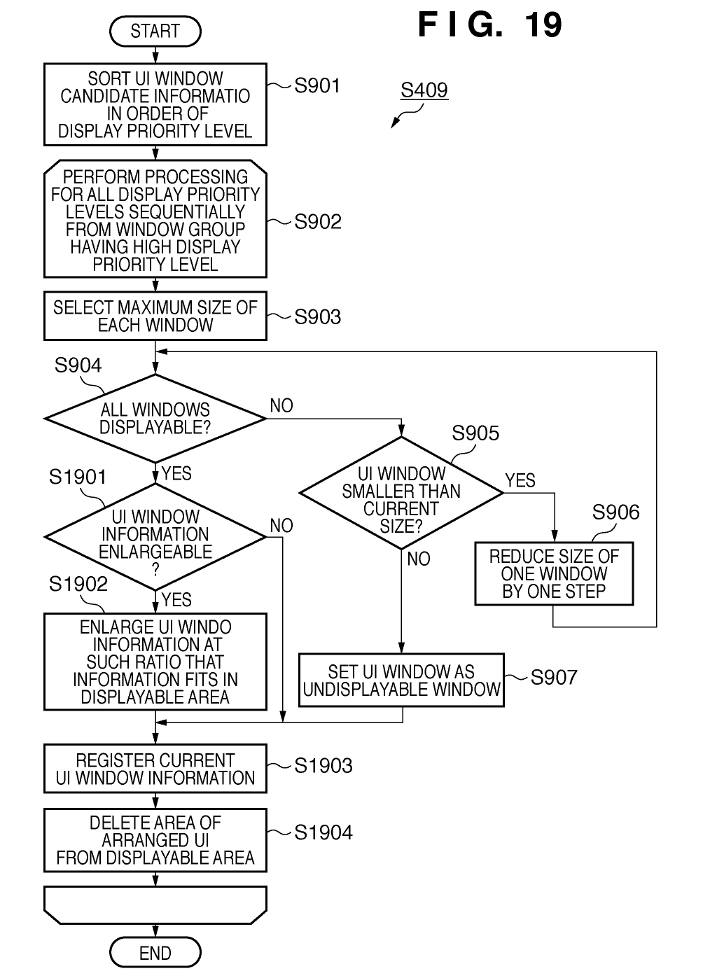

FIG. 19 is a flowchart illustrating processing of determining items of UI window information to be displayed and their layout in step S409 of FIG. 15.

The same step numbers as in FIG. 9 denote the same processing blocks in FIG. 19. The same processing as in FIG. 9 is performed in steps S901 to S907. In this embodiment, if it is determined in step S904 that all windows can be displayed, the process advances to step S1901 to determine whether the UI window candidate information display area is enlargeable. If the UI window candidate information display area is enlargeable in the X and Y directions, the process advances to step S1902.

In step S1902, the possible enlargement ratio of the UI window candidate information display area is calculated based on the displayable area information. In step S1903, the enlargement ratio is registered together with the UI window candidate information. In step S1904, the enlarged display area in which the UI windows are laid out is deleted from the displayable area. The remaining processing blocks are the same as in FIG. 9.

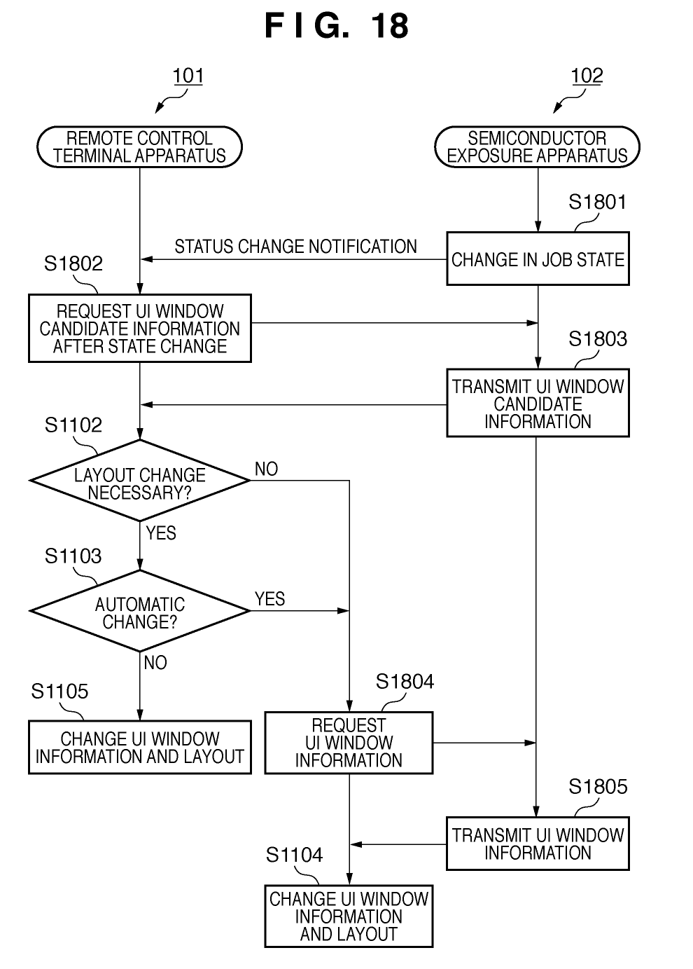

FIG. 18 is a flowchart for explaining layout change processing when the status of the semiconductor exposure apparatus 102 is changed by an operation of another user or termination of processing. The same step numbers as in FIG. 11 denote the same processing blocks in FIG. 18.

When the job state has changed, the semiconductor exposure apparatus 102 notifies the remote control terminal apparatus 101 of the change in the job state in step S1801.

In step S1802, the remote control terminal apparatus 101 requests UI window candidate information after the state change of the semiconductor exposure apparatus 102.

In step S1803, the semiconductor exposure apparatus 102 transmits UI window candidate information in response to the request from the remote control terminal apparatus 101.

In step S1102, the remote control terminal apparatus 101 determines on the basis of the job state and the display priority whether a layout change is necessary. If a layout change is necessary, the process advances to step S1103. Otherwise, the process advances to step S1804.

The user sets in advance whether to change the layout automatically or manually. If it is determined in step S1103 in accordance with the setting that the layout is to be changed automatically, the process advances to step S1804. To change the layout manually, the process advances to step S1105.

In step S1804, the remote control terminal apparatus 101 requests UI window information complying with the layout after the job state change of the semiconductor exposure apparatus 102. In step S1805, the semiconductor exposure apparatus 102 transmits UI window information corresponding to the request to the remote control terminal apparatus 101.

In step S1104, the remote control terminal apparatus 101 changes the layout in the same way as in step S409. In step S1105, the remote control terminal apparatus 101 notifies the user of the status change using the display area before the change without changing the layout. To do this, a dialog may be displayed. Alternatively, the frame of the area may be highlighted or blinked.

If no layout change is necessary in step S1102, only the UI window information is changed.

According to the above-described second embodiment, it is possible to provide an optimum remote control window corresponding to the job state of the semiconductor exposure apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-316359, filed Dec. 6, 2007, which is hereby incorporated by reference herein in its entirety.

What is claimed is:

1. A remote control system including a controlled apparatus and a remote control terminal apparatus which remote-controls the controlled apparatus via a network,
the controlled apparatus comprising:
a management unit configured to manage an apparatus status of the controlled apparatus; and
a generation unit configured to generate UI window candidate information to create, on the remote control terminal apparatus, a remote control window of the controlled apparatus, and
the remote control terminal apparatus comprising:
an acquisition unit configured to acquire display priority information representing a display priority level of each apparatus status of the controlled apparatus, and displayable area information representing a displayable area of the remote control window;
a determination unit configured to receive the UI window candidate information from the controlled apparatus and determine, based on the display priority information and the displayable area information, items of UI window information to be displayed in the received UI window candidate information and a layout thereof; and
a display unit configured to display the remote control window in which the items of UI window information are laid out in the layout determined by said determination unit.

2. The system according to claim 1, wherein the UI window candidate information includes a plurality of items of UI window candidate information having different display sizes corresponding to apparatus statuses of the controlled apparatus.

3. The system according to claim 1, wherein when a display area of the UI window candidate information selected in descending order of display priority is enlargeable, said determination unit enlarges the display area of the UI window candidate information.

4. The system according to claim 1, wherein the UI window information includes minimum necessary size information for display.

5. The system according to claim 1, wherein
the controlled apparatus is a semiconductor exposure apparatus, and
the apparatus status is one of volume semiconductor production by the semiconductor exposure apparatus, tuning of the semiconductor exposure apparatus, and maintenance of the semiconductor exposure apparatus.

6. The system according to claim 1, wherein
the controlled apparatus comprises a semiconductor exposure apparatus,
the remote control terminal apparatus comprises a holding unit configured to hold job information including information representing an execution state of a job in the semiconductor exposure apparatus, and
the display priority level is set in accordance with the execution state of the job represented by the job information.

7. The system according to claim 1, wherein job information includes Operator information representing a name of an operator who has performed a job issue operation, and a display priority level of a job for which a user who has logged in to the remote control terminal apparatus matches the Operator information is set to be higher than that for a job for which the user and the Operator information do not match.

8. A method of controlling a remote control system including a controlled apparatus and a remote control terminal apparatus which remote-controls the controlled apparatus via a network, the method comprising the steps of:
causing the controlled apparatus to:
manage an apparatus status of the controlled apparatus; and
generate UI window candidate information to create, on the remote control terminal apparatus, a remote control window of the controlled apparatus, and
causing the remote control terminal apparatus to:
acquire display priority information representing a display priority level of each apparatus status of the controlled apparatus, and displayable area information representing a displayable area of the remote control window;
receive the UI window candidate information from the controlled apparatus and determine, based on the display priority information and the displayable area information, items of UI window information to be displayed in the received UI window candidate information and a layout thereof; and
display the remote control window in which the items of UI window information are laid out in the layout determined by said determination unit.
